(19) United States
(12) Patent Application Publication
(10) Pub. No.: US 2006/0051571 A1
(43) Pub. Date: Mar. 9, 2006

(54) Article for being applied to a surface and method thereof

(75) Inventors: Mark John Steinhardt, Cincinnati, OH (US); Anneke Margaret Kaminski, Cincinnati, OH (US); Robert Lawrence Prosise, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/203,847

(22) Filed: Aug. 15, 2005

Related U.S. Application Data
(63) Continuation of application No. PCT/US04/04503, filed on Feb. 13, 2004.

(51) Int. Cl. B32B 7/12; C09J 5/02

(52) U.S. Cl. 428/352; 428/335; 428/542.2; 156/324.4

(57) ABSTRACT

The invention comprises a laminated article, such as may be used to apply a functional effect to a surface. The functional effect may be color. The article has plies which preferentially release from one another or adhere to one another as desired for bonding to the surface, either temporarily, for repositionability, or permanently, for long-term use.

### FIELD OF THE INVENTION

This invention relates to articles for applying a color or functional effect to a surface, which articles may be laminated sheets.

### BACKGROUND OF THE INVENTION

Laminated sheets are known in the art. Laminated sheets are usable for applying a color effect to a surface. Such sheets may comprise wallpaper or a dry color component. The color component may comprise pigments secured to a binder, as occurs in paint. The sheets may be adhesively attached to the surface, or attached by other means known in the art, such as cohesion, magnetic attraction, static/electrostatic charge, mechanical means, suction/vacuum, other differential pressures, etc.

The article may be provided in a continuous length of indeterminate width or provided in discrete units. The article may be spiral wound or flat sheets. Further, the articles may be cut out of a continuous roll as discrete units, such as decals.

It is important that upon application of the article to the substrate, the laminated structure remain intact. A particularly preferred laminated structure may comprise, laminae in series, such as a releasable liner, a color component or functional effect, and an adhesive or other bonding agent.

However, it is important that premature delamination of the laminae be avoided. For example, until the article is disposed on the surface, and permanently positioned thereon, it is important that the releasable liner not be removed from the color component—unless it is specifically desired to do so. Likewise, it is important that cohesive failure of the bonding agent or the color component not occur. Further, one may desire to reposition the sheet to assure squareness with a corner, that a true vertical has been achieved, pattern matching, etc. Thus, it is important that the strength of the bond of the article to the substrate not develop too quickly to allow this to occur.

### SUMMARY OF THE INVENTION

The invention comprises an article for providing a functional effect to a surface. The article comprises a laminate comprising laminae in face-to-face relationship. The laminae comprise a sheet providing the functional effect, a bonding agent joined to a first side of the sheet, and a releasable liner removably attached to a second side of the sheet. The functional effect may be color. The sheet may have a specified thickness and application pressure to bond to the surface.

The article may be provided in a wound format, in a cut and stacked format, etc. The article may be manually applied to the surface or applied from a dispenser. The dispenser has internal forces which occur during dispensing. Also a force occurs between the dispenser and the article during dispensing.

The relative forces between the plies may provide that the forces within the dispenser are greater than the cohesive forces of each lamina and the force between the sheet and the releasable liner, as well as the force between the sheet and the bonding agent. Furthermore, as the article is dispensed to a surface, the force bonding the article to the surface is greater than the force between the article and the dispenser upon application to the surface.

### BRIEF DESCRIPTION OF THE DRAWINGS

FIG. 1A is a perspective view of an article according to the present invention wound into a roll.

FIG. 1B is a perspective view of articles according to the present invention arranged in a stack.

FIG. 2 is a vertical sectional view of a portion of the roll of FIG. 1 or of the stack of FIG. 2 while adjacent laminates are being separated.

FIG. 3 is a vertical sectional view of the article of FIG. 2 bonded to a surface while the releasable liner is being removed from the balance of the article.

FIG. 4 is a vertical sectional view of an alternative embodiment according to the present invention.

### DETAILED DESCRIPTION OF SPECIFIC EMBODIMENTS

The invention is directed to articles and methods for applying functional effects, such as color, to a surface. As employed herein, the term “color” is used to refer to a color effect, i.e., an aesthetic difference in color perception. In a specific embodiment, the color effect is a substantially permanent color effect, i.e., a color effect which is not removed or noticeably reduced upon casual contact, light washing, or the like. Thus, a substantially permanent color effect is distinguished from a temporary color effect which can be easily removed or reduced, such as that provided by chalk or crayons. The term “color component” is used herein to refer to the component of the inventive articles that provides the color effect.

Alternatively, the article may provide other functional effects to a surface. For example, the article may provide sound insulation, thermal insulation, texture, indicia/instructions, ultra-violet radiation, bactericides, Mass transfer, time-released odor control, scented walls, Copper Surface, Pet Solutions, glow-in-the-dark walls (e.g., color memory, light memory, differential glow-in-the-dark, photochromic), white-board capability, erasability, cleanability, attachable capability (e.g. hook and loop) for hanging items, pictures, magnetic surfaces, emission of light, heat, sound, self-cleaning, dust-absorbing, reflective for projection (can be smaller area within a wall), acoustically transparent, sound emission, fire resistance, safety net for capturing debris, one-way windows, smoke detection, carbon monoxide detection, alarm for intrusion detection, sound detection, sound responsive, etc. While it is understood that the article according to the present invention may be generally planar and in sheet form, an article having a significant thickness is also contemplated hereunder.

The term “surface” is used herein to refer to any outer layer or boundary of an object or substrate that is capable of receiving a color component thereon. Suitable surfaces may be substantially two-dimensional and flat or substantially three-dimensional and including curves, angled portions or the like. In one embodiment, the surface to which color component is applied using the articles and methods of the invention comprises an architectural surface, i.e., a surface of a building, a building fixture (i.e., appliances), furniture, and the like. The architectural surface may be an interior surface within the building or an exterior surface on an outer portion of the building. Substantially three-dimensional architectural surfaces can include, for example, edge treatments of two-dimensional surfaces such as moldings (e.g., moldings around windows or doorways), floorboards, appliances, furniture, floors, counters and the like. The architectural surface may be permanently installed or may be temporarily installed or portable. The products of the present invention can further be applied to surfaces of articles to give them the same or different texture and/or appearance of architectural surfaces. For example, the products hereof can be used to apply a color layer to appliances, furniture, and other architectural articles. Additional surfaces suitable for application of color using the articles and methods of the present invention will be apparent to those skilled in the art in view of the present disclosure.

References herein to terms such as “vertical”, “horizontal”, “under”, “over”, etc. are made by way of example, and not by way of limitation, to establish a frame of reference. It is understood various other frames of reference may be employed without departing from the spirit and scope of the invention. Those skilled in the art will appreciate that the forces described herein acting on the article are schematic representations of the actual forces exerted on the article components and are distributed throughout the article and/or over a corresponding interface or boundary between adjacent lamina in the article. The following description is given in conjunction with an article 10 having a functional effect comprising color. However, it is to be recognized that this description is given for illustrative purposes only and the claims are not so limited.

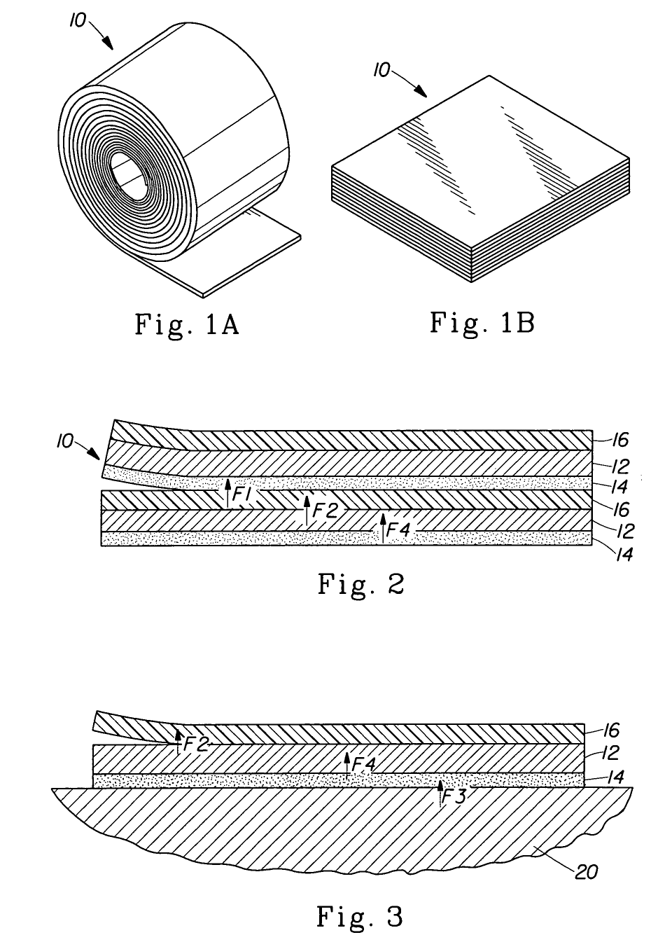

With reference to FIGS. 1A, 1B and 2, an article 10 for applying color on a surface comprises a sheet 12 of color, a bonding agent 14, such as a pressure sensitive adhesive, and a releasable liner 16. Releasable liner 16 is removably coupled with sheet 12 and is intended and adapted for removal shortly after sheet 12 is applied to the desired surface 20 (FIG. 3) or subsequent to application to surface 20. The sheet 12 may include a topcoat 22, for example, comprising a transparent, translucent, pearlescent or opaque coating, for example, providing a gloss, semi-gloss, satin, eggshell, or flat sheen or other optical effects such as diffusion, reflectance or the like, or other beneficial properties. The sheet 12 and bonding agent 14 may have a collective thickness of less than about 0.0033 inch (0.08 millimeters).

The bonding agent 14, which may be any adhesive, such as pressure sensitive adhesive known to those skilled in the art, which is adapted to bond the sheet 12 to the surface 20 upon application of a pressure of less than about 50 lbs/in² (3500 grams/sq. cm). Exemplary articles 10 are described in commonly-assigned application Ser. No. 10/324,237 entitled “Articles and Methods for Applying Color on Surfaces.” The releasable liner 16 may provide structural support and/or strength to the sheet 12, for example when the releasable liner 16 is in film form, and/or to facilitate handling of the article during manufacture, storage and use. The releasable liner 16 may be formed of a sheet of a polymer, such as polyethylene terephthalate (PET), a nonwoven or be cellulosic. Releasable liner 16 may be provided with a release coating, such as a silicone coating, on a surface confronting the sheet 12. The caliper of the releasable liner 16 may be greater than the caliper of the sheet 12.

The article 10 may be provided in wound roll form (FIG. 1A) or, alternatively, provided in a stacked form (FIG. 1B) such that the releasable liner 16 will be positioned adjacent to and in contact with the bonding agent 14. In roll forms, the article 10 may be wound such that the releasable liner 16 faces radially outwardly, as shown in FIG. 2, or may be reverse wound such that the bonding agent 14 faces radially outwardly. Likewise, individually stacked articles 10 (FIG. 1B) may be stacked such that the bonding agent 14 and releasable line 16 are in face-to-face relationship, alternating articles 10 may be transposed or, alternatively, the articles 10 may be arranged in a random orientation.

The article 10 may have a thickness of less than 0.0033 inches (0.076 mm) and preferably less tan 0.003 inches (0.069 mm). The thickness is measured considering only the bonding agent 14 and sheet 12, and no releasable liner 16. Thickness is measured using a 5 mm diameter presser foot under a load of 8.74 gms. An article 10 may be manually applied or by using a dispenser therefor. If a dispenser is utilized, the dispenser may be made according to the teachings of Procter & Gamble U.S. patent application Ser. Nos. 10/458,520, filed Jun. 10, 2003, and 10/700,614, filed Nov. 4, 2003.

To successfully unwind or otherwise separate the bonding agent 14 from the releasable liner 16, a total association (e.g,. unwind or separation) force exhibited between the releasable liner 16 and the bonding agent 14, labeled as F1 on FIG. 2, must be less than a total association (e.g., peel) force exhibited between the sheet 12 and the releasable liner 16, labeled as F2 on FIG. 2. Otherwise, the releasable liner 16 will be secured by the bonding agent 14 to the sheet 12 during unwinding or unstacking, rather than remaining secured to the sheet 12 for removal during subsequent application to the surface 20. Such premature removal or delamination of the releasable liner 16 from the sheet 12 is inappropriate for proper application to a surface 20.

If the article 10 is unwound from a roll form, an unwind force is defined to characterize the adhesive force acting between the releasable liner 16 and the surface of the adjacent portion of sheet 12 contacting the releasable liner 16. Similarly, if the article 10 is arranged in stacked or layered form, a separation force is defined to characterize the adhesive force acting between the releasable liner 16 and the bonding agent 14. The unwind or separation force may be measured in a peel test using a 2.0 inch wide peel strip according a modified version of ASTM D3811 using a Lab Master Release and Adhesion Tester Model 80-90 and a 16 inch (40.6 cm) sample length at a test speed of 720 in (1830). [symbol] In cei of from about 12 inches (30.5 cm) per minute to about 800 inches (2030 cm) per minute and at an angle of less than about 180° and particularly 90 degrees. The angle is measured relative to a tangential plane to the circular roll layer positioned at along the line of release of the bonding agent 14 from the underlying release liner 16, with the releasable liner 16 being the other lamina. In other embodiments of the invention, the unwind force F1 is less than about 100 grams per two inches (5.08 cm) if the roll is unwound at a rate ranging from about 12 inches (30.5 cm) per minute to about 720 inches (1830 cm) per minute. In yet other embodiments of the invention, the unwind force F1 ranges from about 50 grams per two inches (5.08 cm) to about 65 grams per two inches (5.08 cm) if the roll is unwound at a rate ranging from about 180 inches (460 cm) per minute to about 720 inches (1830 cm) per minute. In yet another embodiment, the unwind force is less than 50 grams per two inches (5.08 cm) measure at rates of 12 (30.5 cm) and 300 (760 cm) inches per minute.

In certain embodiments of the invention in which the article 10 does not require unwinding, a separation force F1 required to separate the release liner 16 and bonding agent 14 is less than about 150 grams per two inches (5.08 cm) if separated at a rate of from about 12 inches (30.5 cm) per minute to about 800 inches (2030 cm) per minute. In other embodiments of the invention, the separation force F1 is less than about 100 grams per two inches (5.08 cm) if the release liner 16 and bonding agent 14 are separated at a rate ranging from about 12 inches (30.5 cm) per minute to about 720 inches (1830 cm) per minute. In yet other embodiments of the invention, the separation force F1 ranges from about 50 grams per two inches (5.08 cm) to about 65 grams per two inches (5.08 cm) if the release liner 16 and bonding agent 14 are separated at a rate ranging from about 180 inches (460 cm) per minute to about 720 inches (1830 cm) per minute.

The magnitude of the unwind or separation force F1 may be modified by altering the composition or the chemical constituents of the bonding agent 14. For example, tackifiers and/or crosslinkers may be added to the composition to change the tack of the adhesive. The coating weight or thickness of the bonding agent 14 may also be varied to change the unwind force or separation force. Alternatively, the composition or chemical constituents of the release coating of the releasable liner 16 may be changed to affect the ability to separate from the bonding agent 14 when a roll is unwound or adjacent stacked sheets are separated. The value of the unwind force may also be affected by the tightness or compactness of the roll into which article 10 is wound. If adhesive is used for the bonding agent 14, the adhesive may be chilled to reduce its adhesion to the surface 20. Similarly, the compressive forces used to place release liner 16 into contact with bonding agent 14 may affected the magnitude of the separation force. Forces arising from static charging acting between the bonding agent 14 and the releasable liner 16 may contribute to the value of the unwind or separation force.

With reference to FIG. 3, after the article is applied to the surface 20, the adhesion force between the bonding agent 14 and the surface 20, labeled as F3 on FIG. 3, is greater than about 125 grams per two inches (5.08 cm) in certain embodiments of the invention. The adhesion force F3 is determined by peeling the article 10 from the surface 20 at an angle of less than about 180°, particularly 90 degrees. In other embodiments of the invention, the adhesion force F3 between the bonding agent 14 and the surface 20 is greater than about 180 grams per two inches (5.08 cm) measured at 12 inches (30.5 cm) per minute. While F3 is generally taken as the force between the bonding agent 14 and an external surface 20, the invention is not so limited. For example, F3 may be measured between the bonding agent 14 of a first portion of the article 10 and the sheet 12 of a second portion of article 10. This may occur, for example, if two portions of the article 10 are placed in overlapping relationship, such as at a seam.

The magnitude of the adhesion force F3 may be influenced by the degree of bonding between the bonding agent 14 and the surface 20. Specifically, the magnitude of the adhesion force increases if a coextensive boundary or interface between bonding agent 14 and the surface 20 is substantially free of contaminants. To that end, the condition of surface 20 may be prepared for the application of the article 10 by, for example, wiping the surface 20 in a manner effective to remove any temporarily attached and, hence, 10 removable residue. Removing the residue increases the contact area between surface 20 and bonding agent 14, which increases the strength of the adhesive bond as the intervening residue would otherwise lessen the available surface area of surface 20 for establishing the adhesive bond.

The article 10 is capable of being substantially applied to the surface 20. Factors affecting the establishment of “substantial application” include, but are not limited to, the burnish or smoothing pressure used to apply the article 10 to the surface 20, the surface energy of the surface 20, the presence of loose debris and/or contaminants (e.g., residue from sanding), the surface texture of the surface 20, a coating of paint present on the surface 20 prior to application of the article, the type of paint, if any, on the surface 20 prior to application, the underlying surface characteristics, and any residue (e.g., sizing) from wallpaper removal. Surface texture of the surface 20, and removal of air bubbles affects the degree of contact between portions of the bonding agent 14 and the surface 20 with greater textures reducing the strength of the adhesive bond. If desired, the article 10 may be perforate to allow escape of air therethrough. The degree of adhesion between the bonding agent and the surface 20 will also be influenced by the properties of any existing paint on the surface 20. For example, the degree of bonding may differ among primer, enamel paint, or latex paint, or among gloss, semi-gloss, satin, eggshell, and flat finishes. The bending stiffness of the article 10 also affects the ability of the article 10 to acheive contact and adhesion with the surface 20. Furthermore, if the article 10 is peforate, air may be released therethrough, and increase contact/adhesion of the article 10 to the surface 20.

Particles that may be added to bonding agent 14 include, but are not limited to, carbon black, calcium carbonate, titanium dioxide, silica, satin white, barytes, mica, zinc oxide, plastic pigments, or a kaolin clay pigment, which is composed primarily of kaolinite (a hydrated aluminum silicate (Al₂Si₂O₅(OH)₄)). The particles should be inert when in the matrix of the bonding agent 14. The average or mean diameter of the particles may range from about from about 25 nm to about 150 μm. The composition of the bonding agent 15 may include about 5 percent by weight of particles, with the balance of the composition comprising an organic matrix, although a greater percentage of particles may be used as the bonding agent 14 becomes thicker.

With continued reference to FIG. 3, as the article 10 is applied to the surface 20, the bonding agent 14 adhesively secures the sheet 12 to the surface 20 and the releasable liner 16 is removed to expose the sheet 12. A peel force, labeled as F2 on FIG. 2, characterizes the separation of the releasable liner 16 from the sheet 12, as described above. In certain embodiments of the invention, the peel force F2 between the releasable liner 16 and the sheet 12 is between about 20 grams per two inches (5.08 cm) to about 200 grams per two inches (5.08 cm) when the releasable liner is peeled from the sheet 12 at a rate of about 12 inches (30.5 cm) per minute to about 720 inches (1830 cm) per minute and at an angle of at least about 45°. In other embodiments of the invention, the peel force F2 ranges from about 110 grams per two inches (5.08 cm) to about 150 grams per two inches (5.08 cm) when the releasable liner 16 is peeled from the sheet 12 at a rate of about 12 inches (30 cm) per minute to 300 inches (760 cm) per minute and at an angle of less than about 180°. In yet other embodiments of the invention, the peel force F2 ranges from about 40 grams per two inches (5.08 cm) to about 80 grams per two inches (5.08 cm) when the releasable liner 16 is peeled from the sheet 12 at a rate of from about 12 inches (30 cm) per minute to 300 inches (760 cm) per minute and at an angle of less than about 180°.

In a particularly preferred embodiment the following forces may be used for F1, F2, and F3:

| Force | Acceptable | Preferred | More Preferred |
|---|---|---|---|
| F3 | >125 g/2 in; | >125 g/2 in; | >180 g/2 in; |
| | measured at 12- | measured at 12 ipm; | measured at 12 ipm; |
| | 720 ipm; test | test angle of | test angle of 90° |
| | angle of 180° | <180° | |
| F2 | 20-200 g/2 in; | 40-100 g/2 in; | 40-60 @ |
| | measured at 12- | measured at 12- | measured at 12 ipm, |
| | 720 ipm; test | 300 ipm; test angle | test angle of 90° |
| | angle of <180° | of <180° | 50-75 g/2 in |
| | | | @ 300 ipm, |
| | | | test angle of 90° |
| F1 | <100 g/2 in; | <90 g/2 in; | <70 g/2 in; |
| | measured at 12- | measured at | measured at 180 |
| | 720 ipm; test | 180-720; | ipm-720 ipm; |
| | angle of <180° | test angle of | test angle of 90° |
| | | <180° | |

Modifying the adhesion between the releasable liner 16 and the sheet 12, such as by modifying the contact area between the two components, may result in a modification of the peel force F2. Alterations to the interface between the releasable liner 16 and the sheet 12 operate to modify the adhesion. Likewise, electrostatic charge between the sheet 12 and releasable liner 16 may cause undue affinity between these laminae.

With continued reference to FIG. 3, the adhesion force, labeled as F3 on FIG. 3, between the bonding agent 14 and the surface 20 is less than the peel force F2 so that the sheet 12 remains bonded with the surface 20 as the releasable liner 16 is removed after pressure is applied to bond the sheet 12 to surface 20. In addition, the separation force, labeled as F4 on FIG. 3, between the bonding agent 14 and the sheet 12 is greater than the adhesion force F3 so that, as the releasable liner 16 is removed at the time of application to surface 20, the sheet 12 and bonding agent 14 remain bonded together.

The adhesion force F3 between the bonding agent 14 and the surface 20 at an initial point of application when the article is applied onto a surface 20 is greater than the application force exerted during application of the article 10 and during unwinding of a rolled article 10. Typically, the rolled article 10 is applied or tacked at one position on the surface 20 and unrolled to length, cut and pressed against the surface 20 to establish an adhesive bond. After the initial tacking, the adhesion force over the tacked region should be adequate to permit continued application without loss of adhesion over the tacked region.

Examining the article 10 according to the present invention in further detail, one of skill will realize that both adhesive and cohesive forces are present. With reference to FIGS. 2-3, for example, cohesive force C1 within the releasable liner 16 describes the amount of force necessary to separate a portion of the releasable liner 16 from itself. Cohesive force C3, likewise, describes the cohesive force necessary to cause separation of the sheet 12 from itself. Likewise, cohesive force C5 describes the cohesive force necessary to separate the bonding agent 14 from itself. Furthermore, one of skill will recognize that a dispensing force D6 occurs between the article 10 and a dispenser as the article 10 is applied by that dispenser (not shown). Likewise, a force D7 occurs within the dispenser. The force D7 relates to friction internal to the dispensing system, braking action caused by the dispenser, etc.

At initial presentation to the surface 20, repositionability is needed:
F2>F1 and
F3 (at initiation normal to the surface)<F2 (at initiation normal to the surface)<C1, C3, C5

To dispense the article 10 with the releasable liner 16 in place, the following relationships must hold true at the point of application. Dispenser force D7 must be less than the forces between and cohesive to the layers of the article 10. Also, the attachment force F3 between the article 10 and the surface 20 must be greater than the attractive force between the article 10 and the dispenser. Mathematically, this can be expressed as
D7<C1, F2, C3, F4, C5
and F3 (during application)>D6+D7
and preferably F4>F3>F2.
   it being understood that this equation does not apply if the article 10 is applied to the surface 20 without a dispenser.

Furthermore, if dispensing with the releasable liner 16 still in place
a. F3 (at normal and tangential to the surface at initiation)>D6>F1+D7
b. F2>F1
where D6 is force between article 10 and dispenser, and is the force the user applies to the surface during dispensing and D7 equals the internal friction/resistance of the dispenser.
And if no specific notation to “Normal” or “Tangential” is made, then both apply
   If desired, the dispenser may be powered, in order to reduce its internal forces.

Further, one of skill will recognize that it may be desired to reposition the article 10 after initial application to the surface 20. For example, the article 10 may not be applied in a straight, smooth or horizontal manner. One may wish to remove wrinkles, etc. During repositioning, the force F3 between the bonding agent 14 and the surface 20 must be less than the other forces inherent in the article 10. Mathematically, this can be expressed as
F3 (during repositioning)<C1, F2, C3, F4, C5.

Upon final application to the surface 20, it is important that the bonding force joining the article 10 to the surface 20 be greater than the force between the releasable layer 16 and the sheet 12. Mathematically, this can be expressed as

F3>F21>F2

C, C3, C5>F3 (following any burnish by the user normal and tangential to the surface)>F2 (at initiation of removal of the releasable liner 16 at initiation taken normal and tangential to the surface>F2 (the peel force between the liner 16 and the sheet 12.
   for an article 10 having a releasable liner 16 at the time of application, wherein F2I is the initiation force required to remove the releasable liner 16 from the balance of the article 10. If the releasable liner 16 is already preseparated from the sheet 12, the foregoing equation can be simplified to
F3 (upon repositioning)>F2.

If desired, dispensers are known in the art to spool the releasable liner 16 from the balance of the article 10 during application. If so, it is necessary that the force F3 joining the bonding agent 14 to the surface 20 be less than other forces present in the article 10. Mathematically, this can be expressed as
F3 (at the time of application)<C1, F2I, C3, F4, C5.
C1, C3, C5>F3 (normal and tangential to the surface)≧D6≧(F1+F2+D7)
F2≧F1
   Furthermore, the force between the adhesive and the dispenser must be greater than the force between the sheet 12 and releasable layer 16, plus the force between the bonding agent 14 and the dispenser, plus the force within the dispenser itself. Mathematically, this can be expressed as
F3 (at the time of application)>F2+D6+D7.

Once the releasable liner 16 is removed, one may still wish to reposition the article 10 as noted above. At such time, the adhesive force between the article 10 and the surface 20 must be less than the cohesive strength of the sheet 12, the cohesive strength of the bonding agent 14, and the force therebetween. Mathematically, this can be expressed as
F3 (during repositioning)<C3, F4, C5.

A strength layer may be added as noted below. Even without a strength layer, the following tensile relationship must be observed wherein the force joining the article 10 to the surface 20 is less than the combination of the internal forces noted above. Mathematically, this can be expressed as
F3 (peeled normal to surface)<C3+F4+C5 (each in a tensile mode).
   Cohesive strength may be measured according to ASTM D882 whereas separation of the layer may be measured according to ASTM D3330 following a 15 minute dwell time.

The adhesion between the sheet 12 and the bonding agent 14, between the releasable liner 16 and the sheet 12 and/or between the bonding agent 14 and the releasable liner 16 may be altered by surface treatments. Specifically, the sheet 12 and/or the releasable liner 16 may be surface treated by corona treatment, by roughening of target surface for increasing surface area, by swelling of target surface, intermolecular mixing, by direct coating of bonding agent, by applying heat or pressure during lamination, by including a functionalized polymer to provide covalent or intermolecular bonds, by increasing a surface area of one or more layers by embossing, by brushing or other mechanical methods, or by adding particles or by solvent etching, and combinations thereof. Corona treatment, for example, involves exposure to a high voltage corona discharge supplied by a pair of spaced electrodes.

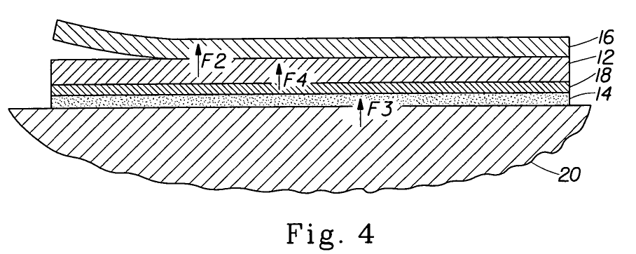

With reference to FIG. 4, the article 10 may further comprise one or more tie layers 18 disposed between the sheet 12 and the bonding agent 14, which enhance the coupling therebetween. Typical tie layers 18 include functionalized polyolefins ethylene acrylate, ethylene vinyl acetate, functionalized acrylics, polyvinyl chloride, polyolefins, polyethoxylate, and combinations thereof and other materials as are known in the art. The tie layers 18 enhance the bonding force between the sheet 12 and the bonding agent 14.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article in combination with a dispenser for conveying color to a surface, comprising:
a sheet of color have opposite first and second sides;
a bonding agent carried by said first side of said sheet of color capable of bonding said sheet to the surface, at least one of said sheet of color and bonding agent being characterized by a thickness of less than about 0.076 mm and said bonding agent being adapted to adhere the article to a surface at room temperature and upon application of a pressure of less than about 50 lbs/in (3500 grams/sq. cm); and
a releasable liner removably attached to said second side of said sheet of color.

2. The article of claim 1 wherein a total association force exhibited between said releasable liner and said bonding agent is less than a total association force exhibited between said sheet and said releasable liner when said article is wound onto a roll so that said releasable liner contacts said bonding agent.

3. An article for conveying color to a surface, comprising:
a sheet of color have opposite first and second sides;
a bonding agent carried by said first side of said sheet of color capable of bonding said sheet to the surface, at least one of said sheet of color and bonding agent being characterized by a thickness of less than about 0.076 mm and said bonding agent being adapted to adhere the article to a surface at room temperature and upon application of a pressure of less than about 50 lbs/in² (3500 grams/sq. cm); and
a releasable liner removably attached to said second side of said sheet of color.
wherein an unwind force required to unwind said article is less than about 150 grams per two inches (5.08 cm), said roll is unwound at a rate of from about 12 inches (30.5 cm)_per minute to about 800 inches (2030 cm) per minute, and said roll is unwound at an angle of less than about 180°.

4. The article of claim 3 wherein said unwind force is less than about 100 grams per two inches (5.08 cm), said roll is unwound at a rate ranging from about 12 inches (30.5 cm)_per minute to about 720 inches (1830 cm)_per minute, and said roll is unwound at an angle of less than about 180°.

5. The article of claim 3 wherein said unwind force ranges from about 50 grams per two inches (5.08 cm) to about 65 grams per two inches (5.08 cm), said roll is unwound at a rate ranging from about 180 inches (460 cm)_per minute to about 720 inches (1830 cm) per minute, and said roll is unwound at an angle of less than about 180°.

6. The article of claim 1 wherein an adhesion force between said bonding agent and the surface is greater than about 125 grams per two inches (5.08 cm) after the article is applied to the surface, said force being determined by peeling said article from the surface at an angle of less than about 180°.

7. The article of claim 6 wherein said adhesion force between said bonding agent and the surface is greater than about 180 grams per two inches (5.08 cm).

8. The article of claim 6 wherein a coextensive interface defined between said bonding agent and the surface is substantially free of contaminants.

9. The article of claim 6 wherein said article is capable of being substantially applied to the surface.

10. The article of claim 1 wherein a peel force between said releasable liner and said sheet is between about 20 grams per two inches (5.08 cm)_to about 200 grams per two inches (5.08 cm) as the article is applied to the surface, said releasable liner being peeled from said sheet at a rate of about 1 inch (2.54 cm) per minute to about 720 inches (1830 cm) per minute and at an angle of at least about 45 degrees.

11. The article of claim 10 wherein said peel force ranges from about 110 grams per two inches (5.08 cm)_to about 150 grams per two inches (5.08 cm), said releasable liner being peeled from said sheet at a rate of about 12 inches (30.5 cm) per minute to 300 inches (760 cm)_per minute and at an angle of less than about 180°.

12. The article of claim 10 wherein said peel force ranges from about 40 grams per two inches (5.08 cm) to about 80 grams per two inches (5.08 cm), said releasable liner being peeled from said sheet at a rate of from about 12 inches (30.5 cm)_per minute to 300 inches (760 cm) per minute and at an angle of less than about 180°.

13. The article of claim 10 wherein a coextensive interface between said bonding agent and the surface is substantially free of contaminants.

14. The article of claim 10 wherein said article is capable of being substantially applied to the surface.

15. The article of claim 1 wherein said article is arranged such that said releasable liner contacts said bonding agent, a total association force exhibited between said releasable liner and said bonding agent is less than a total association force exhibited between said sheet and said releasable liner.

16. The article of claim 15 wherein a separation force required to separate said releasable liner from said bonding agent is less than about 150 grams per two inches (5.08 cm) measured at a separation rate of between about 12 inches (30.5 cm)_per minute and about 800 inches (2030 cm) per minute.

17. The article of claim 16 wherein said separation force is less than about 100 grams per two inches (5.08 cm) measured at a separation rate of between about 300 inches (760 cm) per minute to about 720 inches (1830 cm) per minute.

18. The article of claim 16 wherein said separation force ranges from between about 50 grams per two inches (5.08 cm) to about 65 grams per two inches (5.08 cm) measured at a separation rate of between about 180 inches (460 cm) per minute to 720 inches (1830 cm) per minute.

19. The article of claim 16 wherein a total association force exhibited between said releasable liner and said bonding agent is less than a total association force exhibited between said sheet and said releasable liner.

20. The article of claim I wherein an adhesion force between said bonding agent and the surface is greater than an application force exerted during application of said article and unwinding of said roll from an initial point of application when said article is wound onto a roll and applied onto a surface.

21. The article of claim 1 wherein a lamination force exhibited between said sheet and said bonding agent is greater than a total association force exhibited between said releasable liner and said bonding agent when said article is wound onto a roll.

22. The article of claim 21 wherein said roll is unwound at a rate of from about 12 inches (30.5 cm)_per minute to about 800 inches (2030 cm)_per minute and at an angle of less than about 180°.

23. The article of claim 1 wherein a lamination force exhibited between said sheet and said bonding agent is greater than a total association force exhibited between said sheet and said releasable liner.

24. A laminated article comprising:
a bonding agent for bonding said article to a surface, a sheet providing a functional effect, and a releasable liner releasable from the balance of said article, wherein said sheet is interposed between said bonding agent and said releasable liner, wherein said releasable liner has a cohesive force therein, said sheet has a cohesive force therein, and said bonding agent has a cohesive force therein, and said releasable liner and said sheet have a force therebetween necessary to cause separation of one from the other and said bonding agent and said sheet have a force therebetween necessary to cause separation of one from the other, and wherein said sheet may be applied to a surface by a dispenser, said dispenser having dispensing forces therein which occur when said dispenser dispenses said sheet onto said surface, said dispensing forces of said dispenser being less than said cohesive force of said bonding agent, said cohesive force of said sheet, and said cohesive force of said releasable liner, and said force between said sheet and said releasable liner and said force between said bonding agent and said sheet, furthermore, upon application to a surface, said force bonding said article to said surface being greater than said force between said article and said dispenser as said article is dispensed therefrom.

25. An article according to claim 24 wherein said force between said releasable liner and said sheet decreases after initiation of removal of said releasable liner from said sheet.

26. An article according to claim 25 in combination with a dispenser, said dispenser spooling said releasable liner from the balance of said article upon application to a surface, wherein said force between said releasable liner and said sheet is less than said cohesive force of said releasable liner, said cohesive force of said sheet, said cohesive force of said bonding agent, said force between said releasable liner and said sheet, and said force between said bonding agent and said sheet,
furthermore, wherein said force between said bonding agent and said surface is greater than said force between said releasable liner and said sheet plus said force between said sheet and dispenser and said forces occurring within said dispenser.

27. An article according to claim 26 wherein said article may be repositioned on a surface, and said force between said article and said surface is less than said cohesive force of said sheet plus said cohesive force of said bonding agent plus said force between said bonding agent and said sheet.
